(19) United States
(12) Patent Application Publication
(10) Pub. No.: US 2020/0024518 A1
(43) Pub. Date: Jan. 23, 2020

(54) LIQUID CRYSTAL COMPOUNDS AND USE OF THE SAME IN LIQUID CRYSTAL MEDIUM AND DISPLAY DEVICE

(71) Applicants: DAILY-XIANHUA OPTOELECTRONICS MATERIALS CO., LTD., Kaohsiung City (TW); Yantai Xianhua Chem-Tech Co., Ltd., Yantai (CN)

(72) Inventors: Tsung-Yu Tsai, Kaohsiung City (TW); Ziqian Shi, Yantai (CN); Huan Yin, Yantai (CN); Ming-Chuan Yang, Kaohsiung City (TW); Fengmei Fang, Yantai (CN); Peichuan Feng, Yantai (CN)

(73) Assignees: DAILY-XIANHUA OPTOELECTRONICS MATERIALS CO., LTD., Kaohsiung City (TW); Yantai Xianhua Chem-Tech Co., Ltd., Yantai (CN)

(21) Appl. No.: 16/404,253

(22) Filed: May 6, 2019

(30) Foreign Application Priority Data
Jul. 17, 2018 (CN) 201810781430.X

(51) Int. Cl. C09K 19/32; C09K 19/34; C09K 19/30

(52) U.S. Cl. CPC C09K 19/32; C09K 19/3402; C09K 2019/122; C09K 19/3068; C09K 19/3028; C09K 19/3003

(57) ABSTRACT

Disclosed herein are novel liquid crystal compounds of formula I:

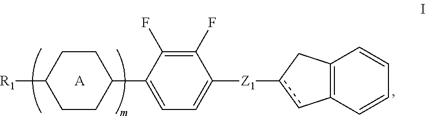

wherein each of the substituents is given the definition as set forth in the Specification and Claims. Also disclosed are liquid crystal media including the novel liquid crystal compounds of formula I, which are suitably applied in an active matrix display device.

### CROSS-REFERENCE TO RELATED APPLICATION

This application claims priority of Chinese Invention Patent Application No. 201810781430.X, filed on Jul. 17, 2018.

### FIELD

The disclosure relates to a liquid crystal compound with an indanyl or indenyl group, and use of the same in the preparation of a liquid crystal medium and a liquid crystal display device.

### BACKGROUND

With the advancement of flat-panel display technology, the thin-film-transistor liquid-crystal display (TFT LCD) plays a leading role in the LCD field.

TFT LCD is usually applied when a stringent requirement with respect to viewing angles is essential, such as in the aviation industry, aerospace industry, medical industry, graphic image processing, etc. However, the contrast ratio of the display might be significantly decreased when viewed off perpendicular, thereby limiting the application of the TFT LCD.

At present, several techniques have been developed to achieve a wide viewing angle, such as: twisted nematic (TN) in combination with a wide film; vertical alignment (VA) including patterned vertical alignment (PVA), multi-domain vertical alignment (MVA), polymer stabilization vertical alignment (PSVA), etc.; in-plane switching (IPS), fringe field switching (FFS), and so forth. Since vertically aligned LCD has a high contrast ratio and a fast response time, it is commonly used in display devices nowadays, especially those with 16.7 M colors and wide viewing angles.

MVA was first developed by Fujitsu Ltd., and is now being adopted by a few manufactures, such as Chi Mei Optoelectronics Corporation, AU Optronics Corporation, etc. The concept of MVA involves the introduction of protrusions on both substrates to produce multi-domains in which the LC molecules are aligned differently from each other. In the off state (i.e., black state), the LC molecules are not perpendicularly aligned in a perfect manner due to the protrusions. In the presence of an electromagnetic field (i.e., on state), the LC molecules tilt in a direction parallel to the substrate surface, so that light can be transmitted therethrough. MVA technology provides a relatively wide viewing angle of more than 160 degrees and a response time shorter than those of IPS and TN in combination with a wide film.

PVA was developed by Samsung Electronics Corp. as an alternative to MVA, and provides an enhanced brightness, and high transmittance and contrast ratio. Instead of applying protrusions such as in MVA, PVA introduces thin patterned-ITO with slits, which results in a perfectly vertically aligned LC cell structure. Later, super PVA (S-PVA) and passive MVA (P-MVA) had been further developed to improve the brightness, response time, and viewing angles.

Moreover, another vertical alignment mode known as the continuous pinwheel alignment (CPA) mode that is aligned by an oblique electric field has been proposed. In the voltage off-state, the LC molecules are vertically aligned in a perfect manner. The bottom sub-pixel has continuously covered electrodes, while the upper one has a smaller area of electrodes that is located in the center of the sub-pixel. In the voltage on-state, the LC molecules tilt towards the center of the sub-pixels because of the electric field, and as a result, a continuous pinwheel alignment is formed. The MVA, PVA and CPA produce normal black (NB) mode display that generates black screen in the absence of applied voltage.

In the polymer stabilized vertical alignment (PSVA) type LCD, which was developed by AU Optronics Corporation and Merck & Co., Inc., photoreactive monomers can be doped in the liquid crystal between the TFT/ITO electrodes with slits of two transparent substrates for forming a mixture with liquid crystal molecules. Subsequently, when a voltage and irradiating ultraviolet (UV) light are applied to the two transparent substrates, a phase separation arises in the photoreactive monomers and the liquid crystal molecules, and a polymer is formed on the alignment layer of the transparent substrates. The liquid crystal molecules are oriented along a direction of the polymer due to the interaction between the polymer and the liquid crystal molecules. Therefore, the liquid crystal molecules between the transparent substrates can have a pre-tilted angle, so as to form multiple domains.

With the advancement of LCD technology, it is important to provide a LCD with a fast response time to meet the market demand. Since the response time may be affected by several properties, such as dielectric anisotropy and rotational viscosity of the liquid crystal, and cell thickness, those skilled in the art, in developing a liquid crystal product, endeavor to improve these properties (e.g. to achieve a decreased rotational viscosity, an increased negative dielectric anisotropy, an enhanced optical anisotropy, etc.).

### SUMMARY

Therefore, an object of the disclosure is to provide a compound suitably serving as a component of a liquid crystal medium that can alleviate at least one of the drawbacks of the prior art.

Another object of the disclosure is to provide a liquid crystal medium and an active matrix display device that can alleviate at least one of the drawbacks of the prior art.

According to this disclosure, the compound has the following formula I:

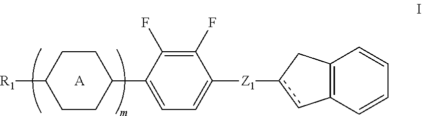

wherein:
R₁ is selected from the group consisting of a C1-C7 alkyl group, a C1-C6 alkoxyl group and a C2-C6 alkenyl group;

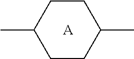

represents

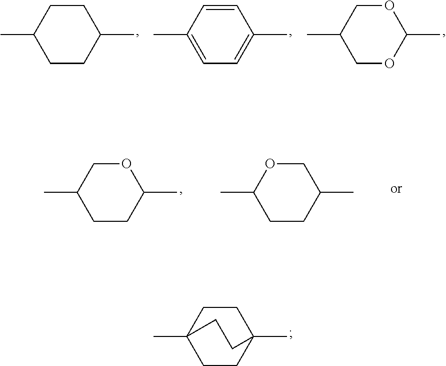

m is an integer selected from 0, 1 and 2, and when m is 2, two of the

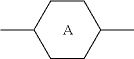

can be the same or different;
Z₁ represents a single bond, —C≡C—, —CH₂—, —CH₂CH₂—, —CH₂O—, —COO—, —CF₂O— or —OCH₂—; and
[symbol] represents a single or double bond.

According to this disclosure, the liquid crystal medium includes the abovementioned compound of formula I.

The active matrix display device of this disclosure includes the abovementioned liquid crystal medium.

Other features and advantages of the disclosure will become apparent in the following detailed description of the embodiment(s).

### DETAILED DESCRIPTION

Unless defined otherwise, all technical and scientific terms used herein have the meaning commonly understood by a person skilled in the art to which the present disclosure belongs.

One skilled in the art will recognize many methods and materials similar or equivalent to those described herein, which could be used in the practice of the present disclosure. Indeed, the present disclosure is in no way limited to the methods and materials described. For clarity, the following definitions are used herein.

The present disclosure provides a compound of formula I, which is suitable for preparing a liquid medium:

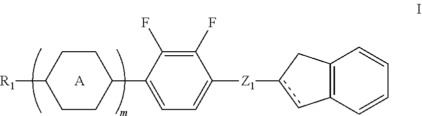

wherein:
R₁ is selected from the group consisting of a C1-C7 alkyl group, a C1-C6 alkoxyl group and a C2-C6 alkenyl group;

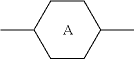

represents

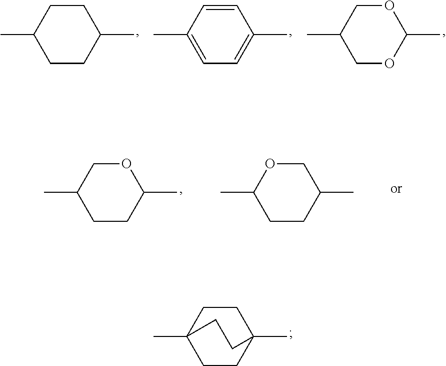

m is an integer selected from 0, 1 and 2, and when m is 2, two of the

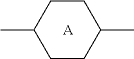

can be the same or different;
Z₁ represents a single bond, —C≡C—, —CH₂—, —CH₂CH₂—, —CH₂O—, —COO—, —CF₂O— or —OCH₂—; and
[symbol] represents a single or double bond.

As used herein, the term “alkyl group” means a saturated, linear or branched hydrocarbon group having a specified number of carbon atoms.

Exemplary linear alkyl groups include, but are not limited to, methyl, ethyl, propyl, butyl, pentyl, and hexyl and heptyl groups. Exemplary branched alkyl groups include, but are not limited to, isopropyl, isobutyl, sec-butyl, tert-butyl, iso-pentyl, tert-pentyl, isohexyl, neohexyl, isoheptyl, neoheptyl, 3-methylhexyl, 2,3-dimethylpentyl, 2,4-dimethylpentyl and 3-ethylpentyl.

As used herein, the term “alkoxy group” refers to an alkyl group as defined above that is linked via an oxygen (i.e., —O-alkyl).

As used herein, the term “alkenyl group” means an unsaturated, linear or branched hydrocarbon group having at least one carbon-carbon double bond, having a specified number of carbon atoms, having a valence of at least one, and optionally substituted with one or more substituents where indicated, provided that the valence of the alkenyl group is not exceeded.

Non-limiting examples of the alkenyl group are vinyl, allyl, n-propenyl, isopropenyl, n-butenyl, 3-methylbutenyl, t-butenyl, n-pentenyl, and sec-pentenyl butenyl, isopropenyl, and isobutenyl pentenyl.

In certain embodiments, the compound of formula I is an indenyl group-containing compound having a formula of I-1 and/or an indanyl group-containing compound having a formula of I-2:

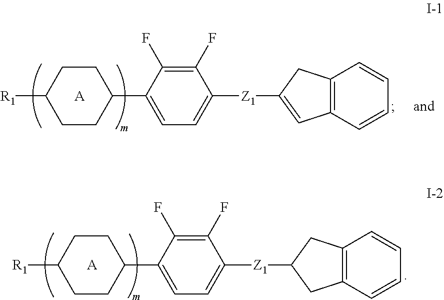

According to the disclosure, the indenyl group-containing compound having a formula of I-1 may be one of the following compounds:

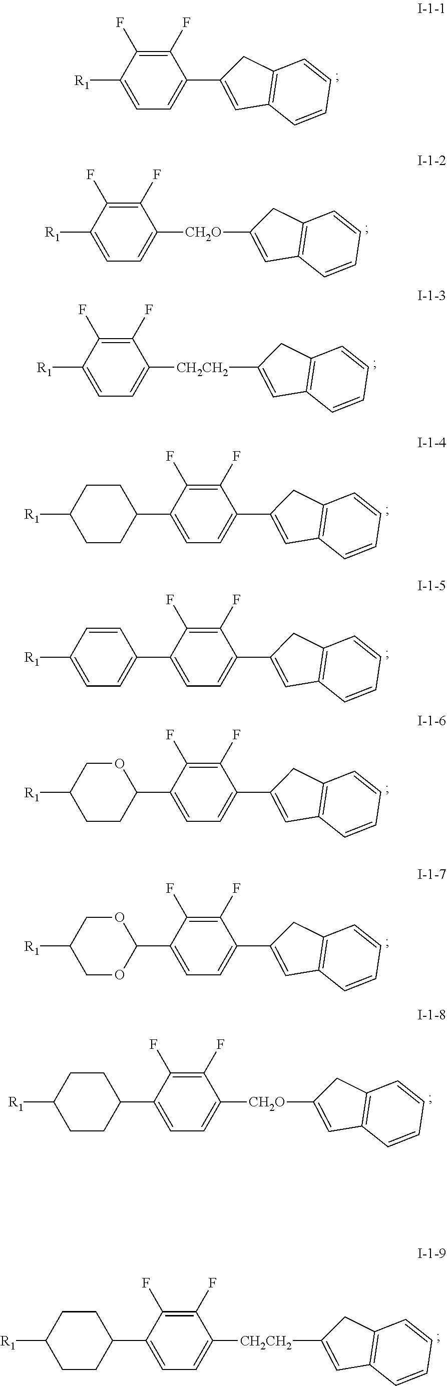

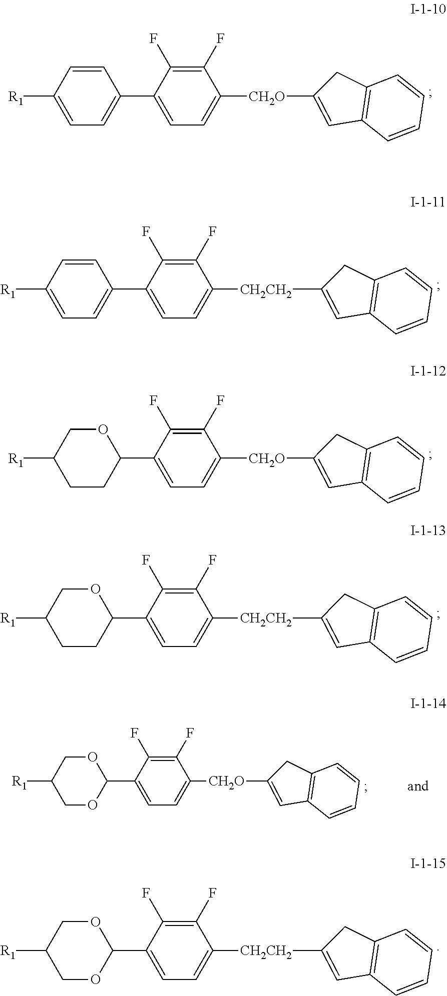

According to the disclosure, the indanyl group-containing compound having a formula of I-2 may be one of the following compounds:

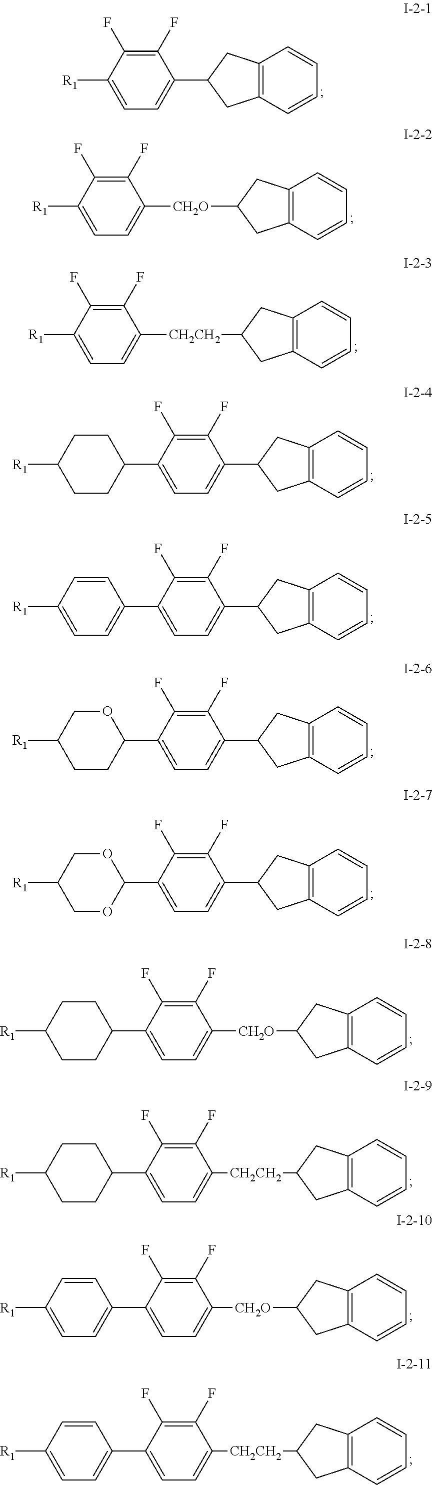

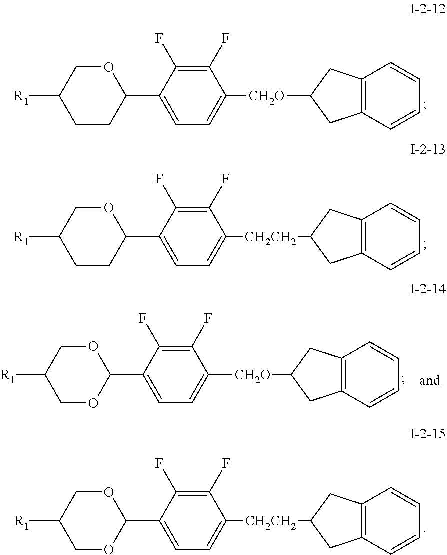

In certain embodiments, in the formulae I-1 and I-2, R₁ is a C1-C6 alkyl group or a C1-C5 alkoxyl group.

According to this disclosure, the compound of formula I-1 may be prepared by the method including the steps of:

(1) reacting

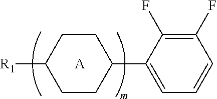

with an organolithium reagent, following by reacting with a borate, so as to obtain

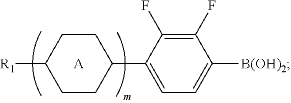

and
(2) subjecting

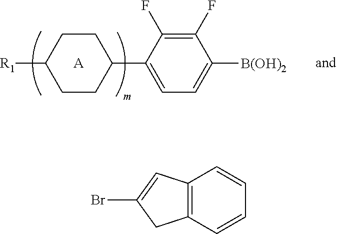

to a Suzuki reaction in the presence of a palladium catalyst and a base.

The compound of formula I-2 may be prepared by the method similar to that for the compound of formula I-1, except for replacing

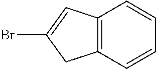

used in the above step (2) with

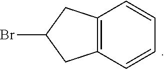

The above step (1) may be conducted at a temperature ranging from −60° C. to −100° C. The organolithium reagent may be at least one selected from the group consisting of n-butyllithium (n-BuLi), sec-butyllithium (s-BuLi), tert-butyllithium (t-BuLi), methyllithium and lithium diisopropylamide. The borate may be at least one selected from the group consisting of trimethyl borate, triisopropyl borate, tributyl borate and triisobutyl borate.

The above step (2) may be conducted at a temperature ranging from 60° C. to 100° C. The palladium catalyst may be at least one selected from the group consisting of Pd[P(C₆H₅)₃]₄, PdCl₂, Pd(OAc)₂ and Bis(triphenylphosphine)palladium chloride. The base may be at least one selected from the group consisting of KOH, NaOH, K₂CO₃, Na₂CO₃, potassium tert-butoxide and sodium tert-butoxide.

In certain embodiments,

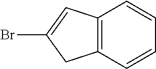

used in the above step (2) is prepared by the steps of:
(a) reacting

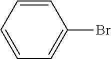

with acrylic acid (i.e., Heck reaction) to obtain

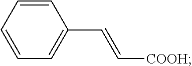 [SMILES: O=C(O)/C=C/c1ccccc1]

(b) subjecting

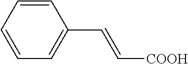 [SMILES: O=C(O)/C=C/c1ccccc1]

to a hydrogenation reaction in the presence of the palladium catalyst, so as to obtain

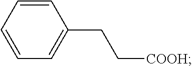 [SMILES: O=C(O)CCc1ccccc1]

(c) reacting

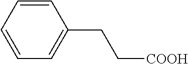 [SMILES: O=C(O)CCc1ccccc1]

with thionyl chloride (as a chlorinating reagent) to obtain

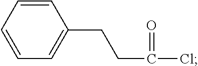 [SMILES: O=C(Cl)CCc1ccccc1]

(d) subjecting

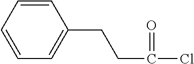 [SMILES: O=C(Cl)CCc1ccccc1]

and AlCl₃ to a cycloaddition reaction, so as to obtain

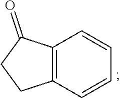

(e) subjecting

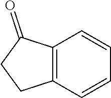

to a bromination reaction using a brominating agent, so as to obtain

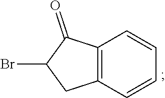 [SMILES: O=C1c2ccccc2CC1Br]

(f) subjecting

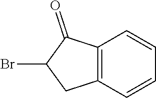 [SMILES: O=C1c2ccccc2CC1Br]

to a reducing reaction using NaBH₄, so as to obtain

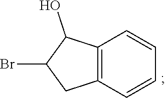 [SMILES: OC1c2ccccc2CC1Br]

and
(g) subjecting

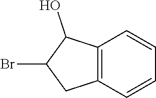 [SMILES: OC1c2ccccc2CC1Br]

and p-toluenesulfonic acid to a dehydration reaction, so as to obtain

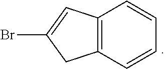

The above step (a) may be conducted at a temperature ranging from 50° C. to 130° C. The step (b) may be conducted at a temperature ranging from 25° C. to 45° C. The steps (c) and (d) may be conducted at a temperature ranging from 4° C. to 45° C. The steps (e) and (f) may be conducted at a temperature ranging from 4° C. to 25° C. The brominating agent used in step (e) may be N-bromosuccinimide (NBS) or Br₂. The step (g) may be conducted at a temperature ranging from 100° C. to 130° C.

In certain embodiments,

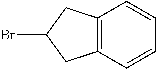

used in the preparation of the compound of formula I-2 is obtained by subjecting

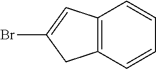

to a hydrogenation reaction in the presence of hydrogen gas and a catalyst (such as the palladium catalyst).

With the indenyl or indanyl group, the compound of formula I may exhibit an excellent stability and have an improved clear point, thereby being suitably applied in the preparation of a liquid crystal medium (i.e., serving a component of a liquid crystal medium). Therefore, the present disclosure provides a liquid crystal medium including the compound of formula I as described above.

In certain embodiments, the liquid crystal medium further includes a compound having the following formula II and a compound having the following formula III:

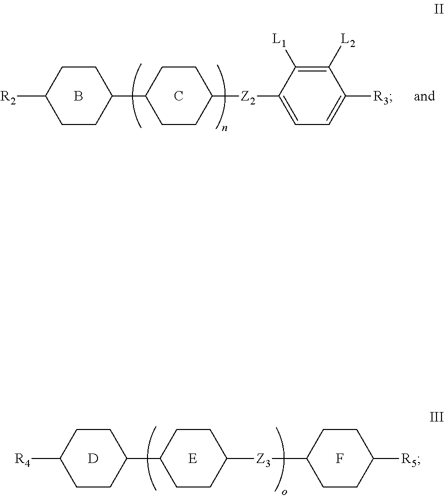

wherein:
R₂, R₃, R₄ and R₅ are independently selected from the group consisting of a C1-C7 alkyl group, a C1-C6 alkoxyl group and a C2-C6 alkenyl group;

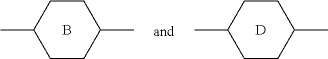

and independently represent

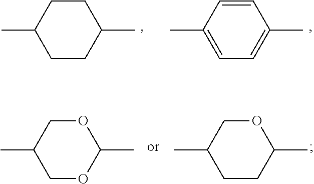

represents

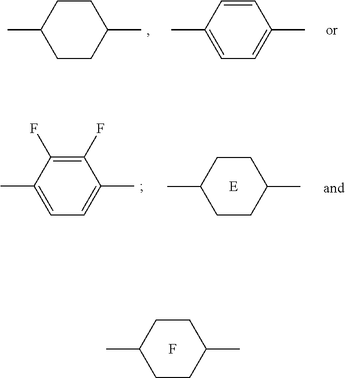

independently represent

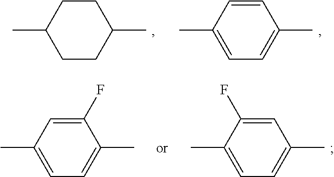

L₁ and L₂ independently represent H or F;
n and o are independently an integer selected from 0, 1 and 2, and when n is 2, two of the

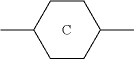

can be
the same or different, and when o is 2, two of the

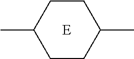

can be the same or different and two of the Z₃ can be the same or different; and
Z₂ and Z₃ independently represent a single bond, —C≡C—, —CH₂—, —CH₂CH₂—, —CH₂O—, —COO—, —CF₂O— or —OCH₂—;
with the proviso that
when Z₂ is a single bond and only one of L₁ and L₂ is F,

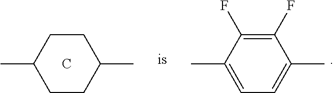

In certain embodiments, the compound of formula II is selected from the group consisting of:

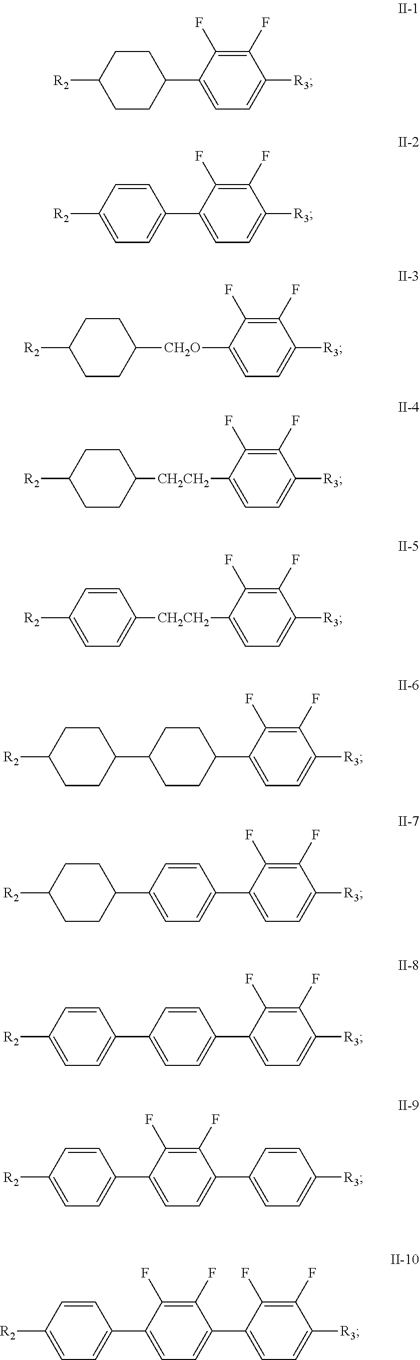

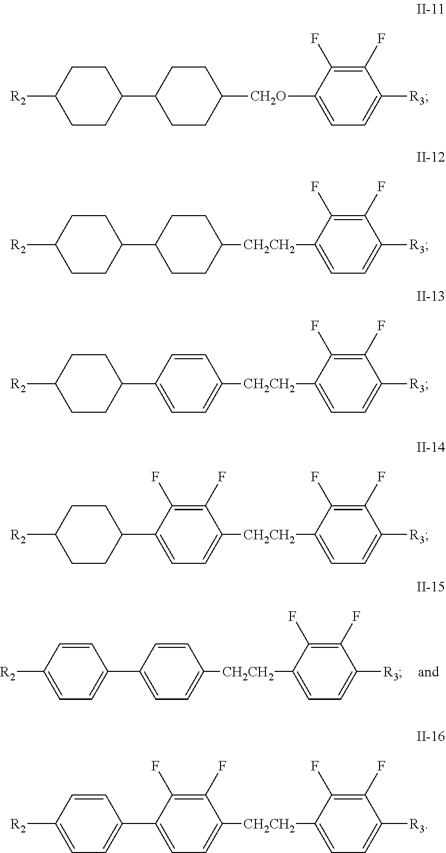

In other embodiments, the compound of formula III is selected from the group consisting of:

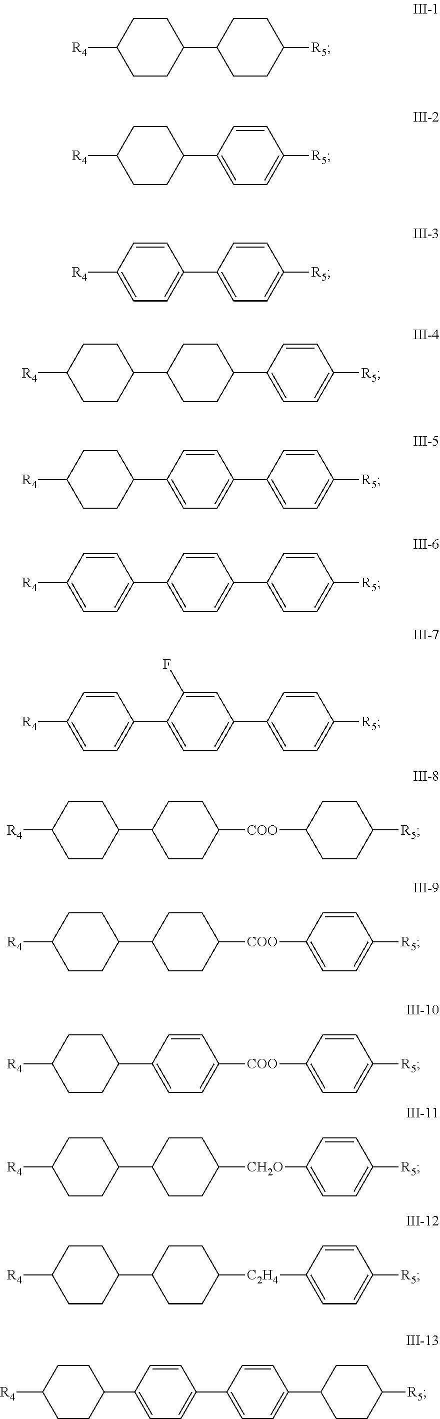

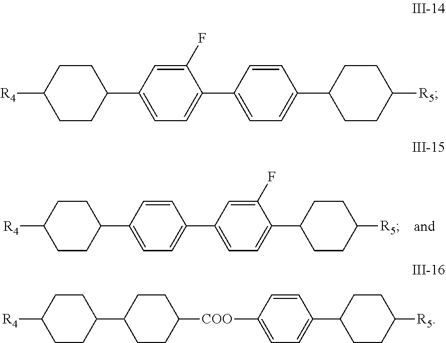

In certain embodiments, based on the total weight of the liquid crystal medium, the compound of formula I is present in an amount of from 1 wt % to 40 wt %, the compound of formula II is present in an amount of from 1 wt % to 70 wt %, and the compound of formula III is present in an amount of from 10 wt % to 70 wt %.

In certain embodiments, based on the total weight of the liquid crystal medium, the compound of formula I is present in an amount of from 1 wt-% to 25 wt %, the compound of formula II is present in an amount of from 20 wt % to 70 wt %, and the compound of formula III is present in an amount of from 10 wt % to 60 wt %.

In addition to the above liquid crystal compounds, the liquid crystal medium of this disclosure may further include one or more additives, such as UV stabilizers, light absorbers, antioxidants, chiral agents, and thermal stabilizers.

The liquid crystal medium of this disclosure has been tested and exhibits a high clear point, a desired optical anisotropy, a high negative dielectric anisotropy, a low rotational viscosity and a fast response time, and thus is suitable for application in an active matrix display device with a low cell thickness and a high resolution.

Therefore, the present disclosure also provides an active matrix display device including the liquid crystal medium as described above.

Examples of the active matrix display device includes, but are not limited to, a liquid crystal display of in-plane switching (IPS) mode, fringe field switching (FFS) mode, vertical alignment (VA) mode, multi-domain vertical alignment (MVA) mode, patterned vertical alignment (PVA) mode, polymer stabilization vertical alignment (PSVA) and electrically controlled birefringence (ECB) mode.

The present disclosure will be further described in the following examples. However, it should be understood that the following examples are solely intended for the purpose of illustration and should not be construed as limiting the present disclosure in practice.

### EXAMPLES

Unless otherwise noted, all percentages shown in the following examples are on a weight basis (i.e., weight percentage, wt %) and temperatures are in degrees Celsius.

The liquid crystal compounds of formulae I-1 and I-2 used in the following examples to prepare a crystal liquid medium are synthesized according to the methods as mentioned above. The liquid crystal compounds of formulae II and III used in the following examples are commercially available, or may be synthesized according to the methods known in the art. These synthetic methods are conventional and routine techniques, and the liquid crystal compounds thus prepared have been tested to meet the criteria for the electronic compounds.

For the convenience of expression, the unit structures of the liquid crystal compounds in the following examples are represented by the codes listed in Table 1.

TABLE 1

| Code | Unit structure | Code | Unit structure |
|---|---|---|---|
| A | 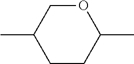 | I | —CH₂O— |
| B | 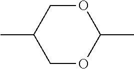 | M | 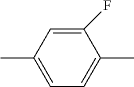 |
| C | 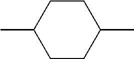 | O | —O— |
| D | ═ | P | 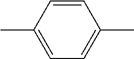 |
| E | —COO— | U | 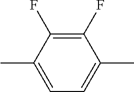 |
| G | —C₂H₄— | W | 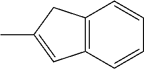 |
| 1-5 | C1-C5 alkyl group | Y | 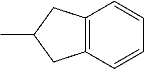 |
| (2D) | —CH═CH₂ | (41D) | —CH₂CH₂CH═CH₂ |
| (32D) | —CH═CHCH₃ | | |

For example, the structures exemplified in Table 2 can be expressed as the corresponding codes shown in Table 1. The underlined code represents the functional group (s) on the left of the core structure, and the bold code represents the functional group(s) on the right of the core structure.

TABLE 2

| Structure | Corresponding code |
|---|---|
| 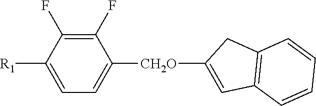 | UIW-R₁ |
| 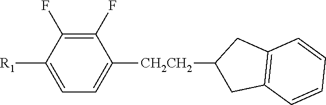 | UGY-R₁ |
| 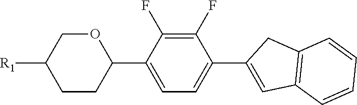 | AUW-R₁ |
| 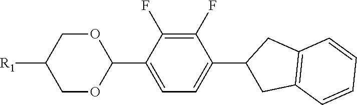 | BUY-R₁ |
| 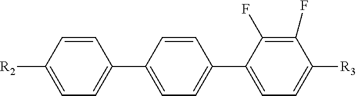 | PPU-R₂R₃ |
| 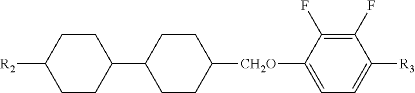 | CCIU-R₂R₃ |
| 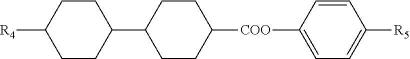 | CCEP-R₄R₅ |
| 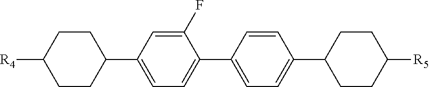 | CMPC-R₄R₅ |

Ten liquid crystal media of the following Examples 1 to 10 are prepared by mixing each of the liquid crystal compounds specified in the respective one of the following Tables 3 to 12 based on the conventional techniques. For instance, each liquid crystal compound was dissolved in a respective suitable solvent (such as acetone, chloroform, methanol, etc.), and then mixed under heating, followed by removal of the solvent(s) through vacuum distillation.

The liquid crystal media obtained in each of Examples 1 to 10 were subjected to the following test to determine properties thereof:
1. Cp (° C.), which represents clearing point of the liquid crystal medium, is the temperature at which a liquid crystal phase of the liquid crystal medium is converted to the isotropic liquid. The clearing point of the liquid crystal medium was measured under heating and observed using a microscope.
2. S—N(° C.) represents the temperature for the transition from the smectic phase (S) to the nematic phase (N) of the liquid crystal medium, and was determined as follows. The test liquid crystal medium was added into a liquid crystal box, and then placed in a freezer maintained at −30° C. or −40° C. to observe the crystallization of the test liquid crystal medium.
3. Δn, which represents optical anisotropy, was measured at 25° C. and 589 nm by an Abbe refractometer and calculated from the equation: Δn=nₑ−nₒ, in which nₒ is the refractive index of an ordinary light, and nₑ is the refractive index of an extraordinary light. The desired range of Δn for the liquid crystal medium of this disclosure is between 0.065 to 0.200.
4. Δε which represents dielectric anisotropy, is calculated from the equation: Δε=ε//−ε1, in which ε_{//} is a dielectric permittivity parallel t a molecular axis, and ε1 is a dielectric permittivity perpendicular to the molecular axis. The test liquid crystal medium was placed in a 20 micron parallel cell without addition of a chiral agent and then measured at 25° C. using an instrument available from INSTEC (ALCT-IP1). The desired range of Δε for the liquid crystal medium of this disclosure is between −2 to −11.
5. γ1 (mPa·s), which represents rotational viscosity, was determined by placing the test liquid crystal medium in the 20 micron parallel cell without addition of a chiral agent followed by measurement at 25±0.2° C. using the instrument available from INSTEC (ALCT-IR1). The lower the rotational viscosity of the test liquid crystal medium is, the faster the response is. The desired range of γ1 for the liquid crystal medium of this disclosure is between 25 to 150.

The properties thus determined for the liquid crystal medium of each of Example 1 to 10 are shown in Tables 3 to 12.

### Example 1

TABLE 3

| Code of the compound | Formula | Wt (%) | Test properties |
|---|---|---|---|
| CC-(2D)3 | III | 30 | S—N: ≤ −40° C. |
| CC-(32D)3 | III | 7 | Cp: 80° C. |
| UIW-3 | I-1 | 5 | Δn: 0.095 |
| AUY-3 | I-2 | 5 | Δ∈: −4.1 |
| CAU-21 | II | 8 | γ1: 92 mPa · s |
| CCU-31 | II | 6 | |
| CCU-3O2 | II | 8 | |
| CCU-2O2 | II | 5 | |
| CPU-3O2 | II | 5 | |
| CPU-2O2 | II | 6 | |
| CUGU-3O2 | II | 6 | |
| CCIU-3O2 | II | 9 | |

### Example 2

TABLE 4

| Code of the compound | Formula | Mass (%) | Test properties |
|---|---|---|---|
| CC-(2D)3 | III | 20 | S—N: ≤ −40° C. |
| CC-5O1 | III | 3 | Cp: 87° C. |
| CC-35 | III | 5 | Δn: 0.101 |
| CUIW-3 | I-1 | 3 | Δ∈: −5.0 |
| CUIY-2 | I-2 | 2 | γ1: 103.7 mPa · s |
| CU-3O2 | II | 20 | |
| CCU-2O2 | II | 8 | |
| CCU-3O2 | II | 8 | |
| CPU-3O2 | II | 6 | |
| CPU-4O2 | II | 9 | |
| PPU-5O2 | II | 5 | |
| CCIU-3O2 | II | 8 | |
| CUGU-3O2 | II | 3 | |

### Example 3

TABLE 5

| Code of the compound | Formula | Wt (%) | Test properties |
|---|---|---|---|
| CC-35 | III | 5 | S—N: ≤ −30° C. |
| CC-32 | III | 25 | Cp: 85° C. |
| PP-15 | III | 7 | Δn: 0.100 |
| CPP-33 | III | 4 | Δ∈: −3.3 |
| CMPC-32 | III | 4 | γ1: 82 mPa · s |
| UIW-3O2 | I-1 | 5 | |
| PUW-32 | I-1 | 8 | |
| AUIW-2 | I-1 | 6 | |
| CCU-3O2 | II | 8 | |
| CPU-2O2 | II | 10 | |
| CPU-4O2 | II | 8 | |
| PU-5O2 | II | 10 | |

### Example 4

TABLE 6

| Code of the compound | Formula | Wt (%) | Test properties |
|---|---|---|---|
| CC-(2D)3 | III | 12 | S—N: ≤ −30° C. |
| PP-(41D)1 | III | 4 | Cp: 90° C. |
| CPP-33 | III | 4 | Δn: 0.148 |
| CUY-3 | I-2 | 5 | Δ∈: −3.9 |
| UIY-3 | I-2 | 10 | γ1: 142 mPa · s |
| PUW-2 | I-1 | 5 | |
| PUP-24 | II | 10 | |
| PPU-2O2 | II | 5 | |
| PUP-23 | II | 10 | |
| PPU-24 | II | 10 | |
| PU-3O2 | II | 10 | |
| CIU-3O1 | II | 10 | |
| CCIU-4O2 | II | 5 | |

### Example 5

TABLE 7

| Code of the compound | Formula | Wt (%) | Test properties |
|---|---|---|---|
| CC-32 | III | 23 | S—N: ≤ −30° C. |
| CC-35 | III | 10 | Cp: 75° C. |
| CP-3O2 | III | 5 | Δn: 0.094 |
| CPP-33 | III | 6 | Δ∈: −2.4 |
| CC-(32D)3 | III | 10 | γ1: 80 mPa · s |
| UW-3 | I-1 | 6 | |
| UGW-2 | I-1 | 5 | |
| AUIW-3 | I-1 | 8 | |
| BUGY-3 | I-2 | 4 | |
| PUP-33 | II | 12 | |
| PPU-23 | II | 6 | |
| CCIU-2O2 | II | 5 | |

### Example 6

TABLE 8

| Code of the compound | Formula | Wt (%) | Test properties |
|---|---|---|---|
| CC-(2D)3 | III | 29 | S—N: ≤ −40° C. |
| CC-(32D)3 | III | 10 | Cp: 90° C. |
| CCP-(41D)1 | III | 10 | Δn: 0.081 |
| CUW-3 | I-1 | 5 | Δ∈: −4.2 |
| CUIY-3 | I-2 | 6 | γ1: 109 mPa · s |
| PUW-2 | I-1 | 3 | |
| CUIY-3 | I-2 | 5 | |
| CIU-3O2 | II | 13 | |
| CCGU-3O4 | II | 8 | |
| PUU-4O2 | II | 1 | |
| CU-3O2 | II | 10 | |

### Example 7

TABLE 9

| Code of the compound | Formula | Wt (%) | Test properties |
|---|---|---|---|
| CC-35 | III | 10 | S—N: ≤ −40° C. |
| CUGY-4 | I-2 | 6 | Cp: 78° C. |
| CUIY-2 | I-2 | 5 | Δn: 0.100 |
| AUIY-3 | I-2 | 5 | Δ∈: −5.6 |
| PUP-32 | II | 7 | γ1: 97 mPa · s |
| CCU-(32D)O2 | II | 8 | |
| CPU-2O2 | II | 5 | |
| CPU-4O2 | II | 5 | |
| CCU-3O2 | II | 8 | |
| CU-3O2 | II | 18 | |
| CU-3O4 | II | 15 | |
| CU-5O2 | II | 8 | |

### Example 8

TABLE 10

| Code of the compound | Formula | Wt (%) | Test properties |
|---|---|---|---|
| CC-(2D)3 | III | 28 | S—N: ≤ −40° C. |
| CCP-(2D)1 | III | 7 | Cp: 80° C. |
| CPP-33 | III | 3 | Δn: 0.097 |
| CP-3O2 | III | 8 | Δ∈: −3.1 |
| CC-32 | III | 7 | γ1: 90 mPa · s |
| CC-(32D)3 | III | 7 | |
| CUGW-3 | I-1 | 5 | |
| CUY-2 | I-2 | 5 | |
| UW-3 | I-1 | 5 | |
| CCU-31 | II | 2 | |
| CPU-3O2 | II | 9 | |
| CPU-2O2 | II | 9 | |
| PUP-23 | II | 3 | |
| CU-3O4 | II | 2 | |

### Example 9

TABLE 11

| Code of the compound | Formula | Wt (%) | Test properties |
|---|---|---|---|
| CC-(2D)3 | III | 17 | S—N: ≤ −30° C. |
| CCD-(41D)1 | III | 7 | Cp: 97° C. |
| CCP-32 | III | 4 | Δn: 0.111 |
| CCEP-33 | III | 3 | Δ∈: −3.7 |
| CCEPC-33 | III | 5 | γ1: 125 mPa · s |
| UIW-3 | I-1 | 5 | |
| UW-2 | I-1 | 5 | |
| AUIW-3 | I-1 | 5 | |
| CCU-(32D)O2 | II | 10 | |
| CPU-3O2 | II | 8 | |
| CPU-2O2 | II | 5 | |
| PUP-23 | II | 7 | |
| PU-3O4 | II | 7 | |
| CU-3O2 | II | 12 | |

### Example 10

TABLE 12

| Code of the compound | Formula | Wt (%) | Test properties |
|---|---|---|---|
| CC-32 | III | 20 | S—N: ≤ −40° C. |
| CC-35 | III | 10 | Cp: 75° C. |
| CCP-33 | III | 3 | Δn: 0.112 |
| PP-15 | III | 8 | Δ∈: −3.0 |
| PP-(41D)1 | III | 5 | γ1: 98 mPa · s |
| CUY-2 | I-2 | 1 | |
| CCIU-3O2 | II | 3 | |
| CCGU-3O2 | II | 2 | |
| CCU-3O2 | II | 7 | |
| CPU-3O2 | II | 9 | |
| CPU-2O2 | II | 9 | |
| PPU-3O2 | II | 3 | |
| PU-3O2 | II | 15 | |
| PPU-5O2 | II | 5 | |

As shown in Tables 3 to 12, the liquid crystal media of this disclosure, which includes the compound of formula I-1 and/or I/2 (negative dielectric anisotropy), the compounds of formula II (negative dielectric anisotropy) and the compound(s) of formula III (dielectric neutrality), have a high negative dielectric anisotropy, a high clear point, desired optical anisotropy and stability, and a low rotational viscosity so as to achieve a faster response time.

To sum up, by having an indenyl or indanyl group, the novel liquid crystal compound of formula I-1 or 1-2 of this disclosure can exhibit an excellent stability and has a high clear point. In addition, the liquid crystal medium containing such indenyl group or indanyl group-containing compound can also has a high clear point, a desired optical anisotropy, a high negative dielectric anisotropy, a low rotational viscosity and a fast response time, and therefore is particularly suitable for application in an active matrix (such as MVA and PVA) display device with a low cell thickness and a high resolution.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A compound having the following formula I: 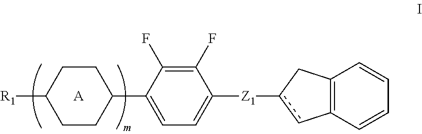
wherein:
R₁ is selected from the group consisting of a C1-C7 alkyl group, a C1-C6 alkoxyl group and a C2-C6 alkenyl group; 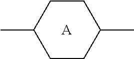
represents 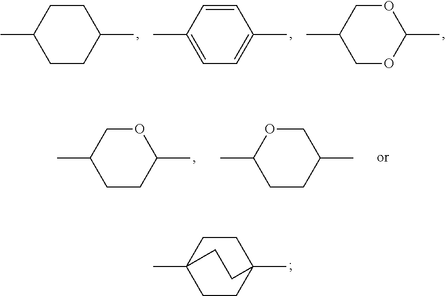
m is an integer selected from 0, 1 and 2, and when m is 2, two of the 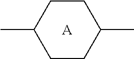
can be the same or different;
Z₁ represents a single bond, —C≡C—, —CH₂—, —CH₂CH₂—, —CH₂O—, —COO—, —CF₂O— or —OCH₂—; and [symbol]
represents a single or double bond.

2. The compound as claimed in claim 1, which is an indenyl group-containing compound having a formula I-1 of 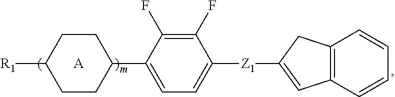
and is selected from the group consisting of:

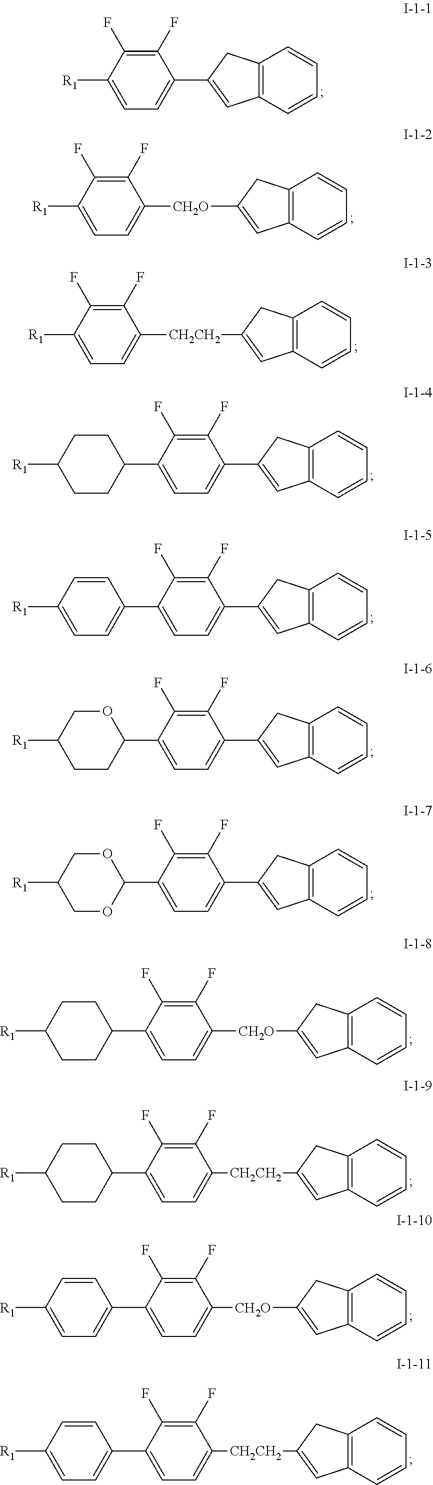

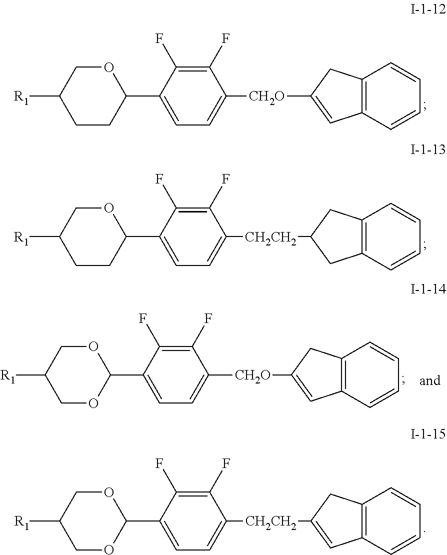

3. The compound as claimed in claim 1, which is an indanyl group-containing compound having a formula I-2 of 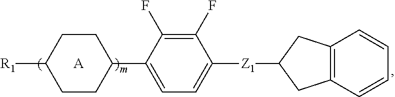
and is selected from the group consisting of:

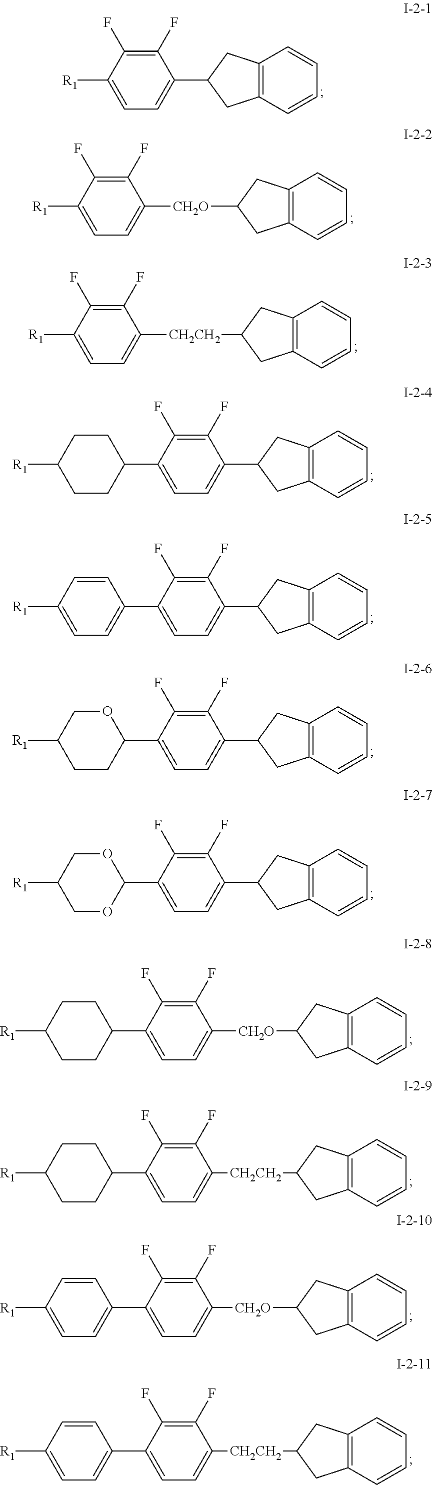

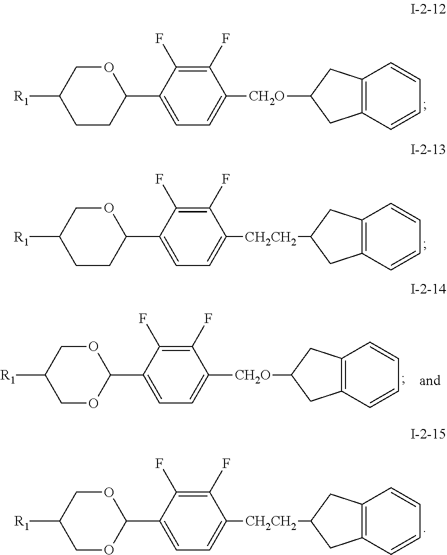

4. A liquid crystal medium, comprising a compound as claimed in claim 1.

5. The liquid crystal medium as claimed in claim 4, wherein the compound is an indenyl group-containing compound having a formula I-1 of 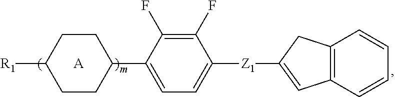
and is selected from the group consisting of:

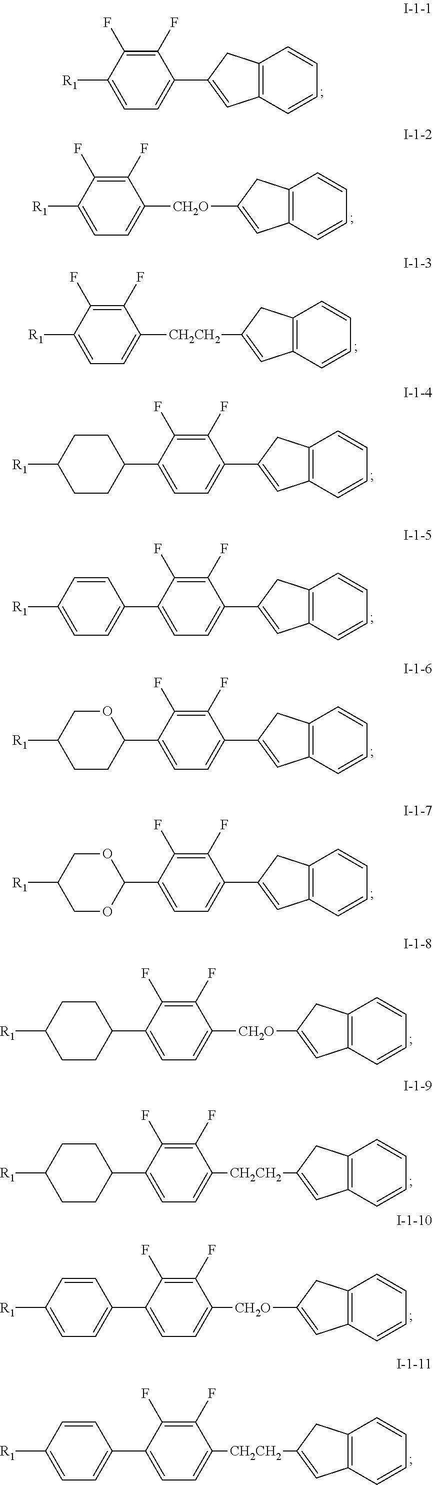

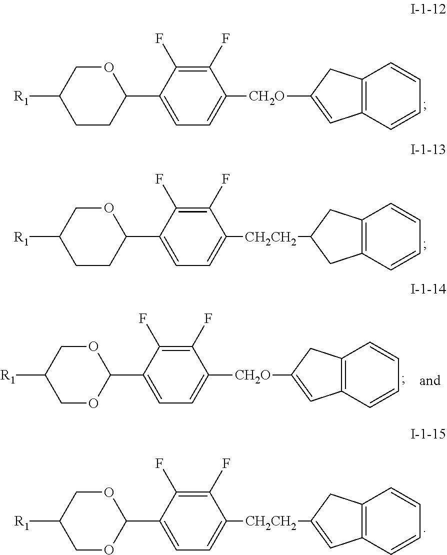

6. The liquid crystal medium as claimed in claim 4, wherein the compound is an indanyl group-containing compound having a formula I-2 of 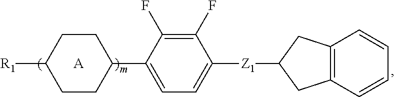
and is selected from the group consisting of:

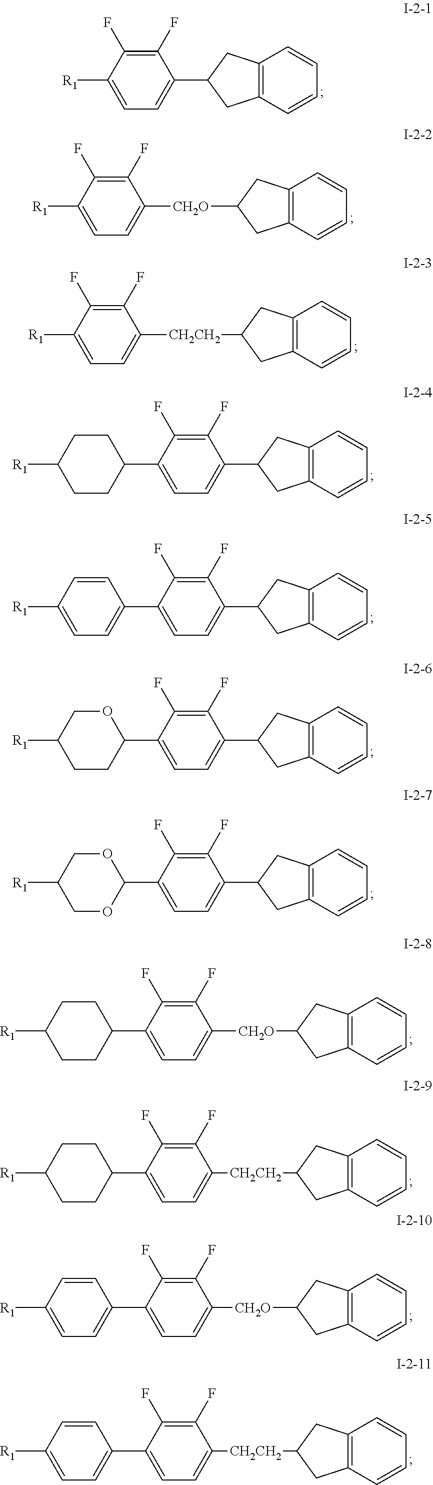

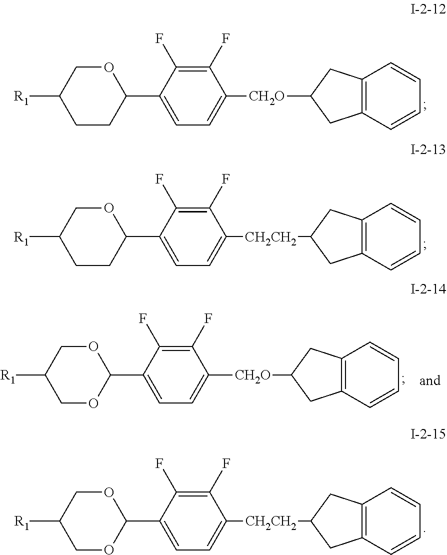

7. The liquid crystal medium as claimed in claim 4, further comprising a compound having the following formula II and a compound having the following formula III: 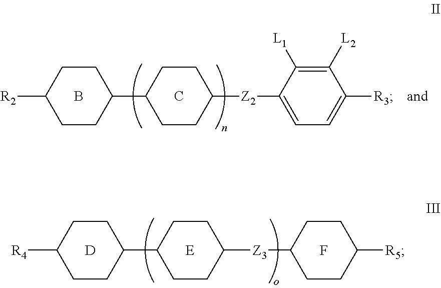
wherein:
R₂, R₃, R₄ and R₅ are independently selected from the group consisting of a C1-C7 alkyl group, a C1-C6 alkoxyl group and a C2-C6 alkenyl group; 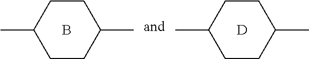
independently represent 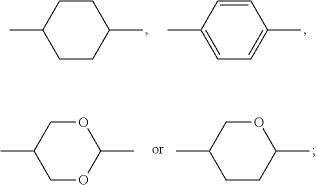 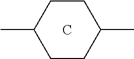
represents 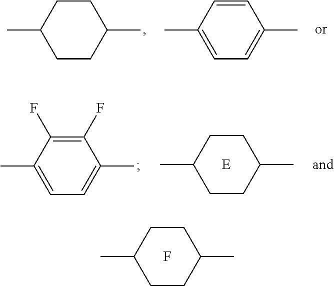
independently represent 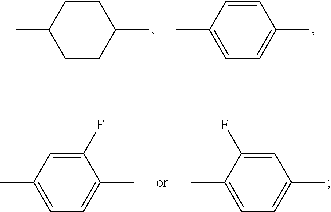
L₁ and L₂ independently represent H or F;
n and o are independently an integer selected from 0, 1 and 2, and when n is 2, two of the 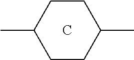
can be the same or different, and when o is 2, two of the 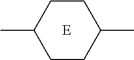
can be the same or different and two of the Z₃ can be the same or different; and
Z₂ and Z₃ independently represent a single bond, —C≡C—, —CH₂—, —CH₂CH₂—, —CH₂O—, —COO—, —CF₂O— or —OCH₂—;
with the proviso that
when Z₂ is a single bond and only one of L₁ and L₂ is F,

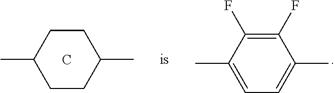

8. The liquid crystal medium as claimed in claim 7, wherein said compound of formula II is selected from the group consisting of:

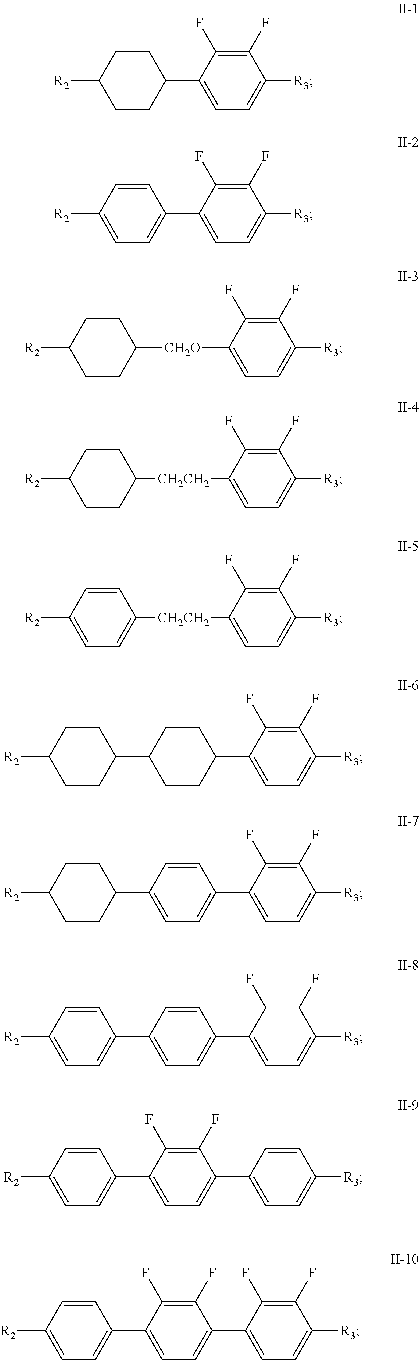

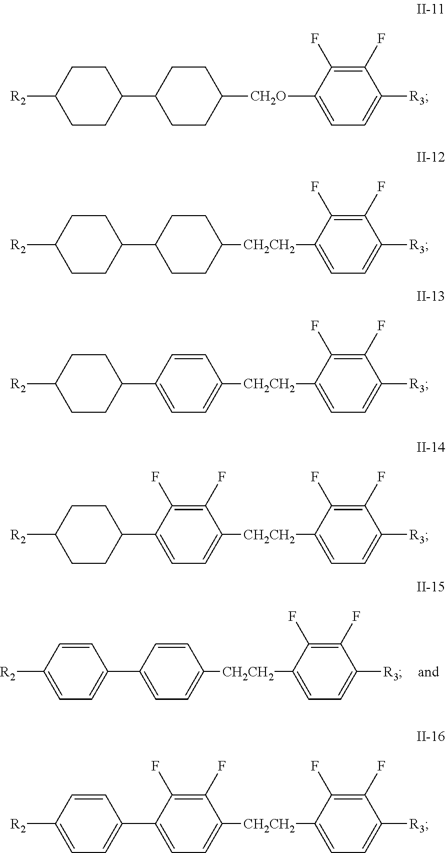

9. The liquid crystal medium as claimed in claim 7, wherein said compound of formula III is selected from the group consisting of:

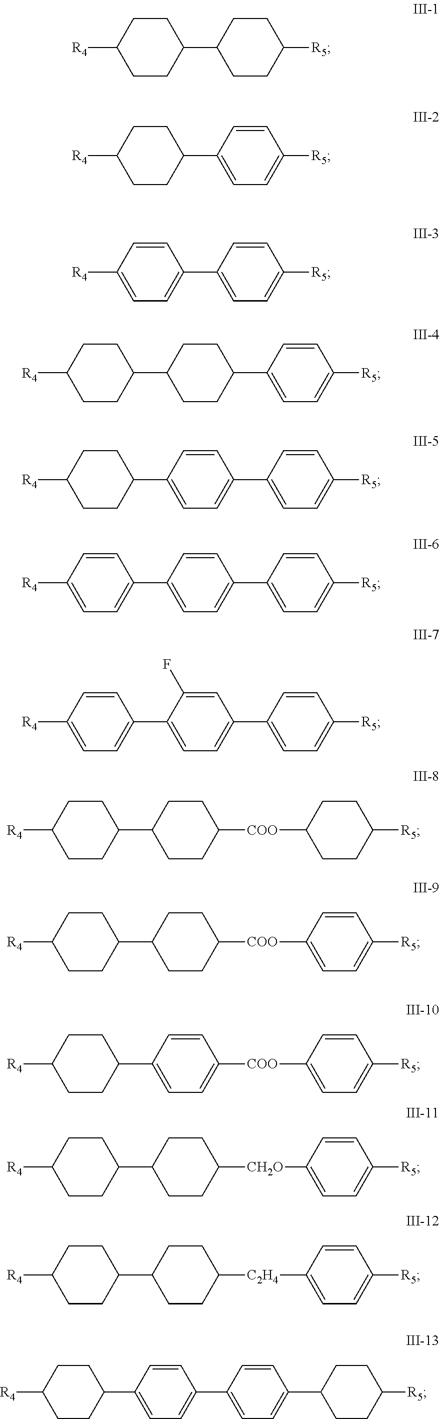

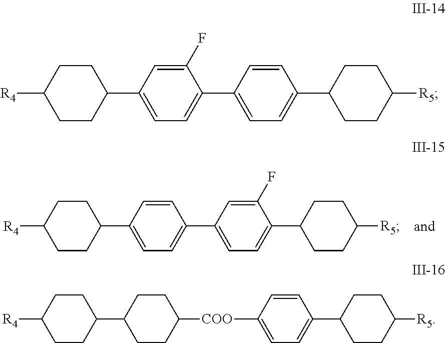

10. The liquid crystal medium as claimed in claim 7, wherein based on the total weight of said liquid crystal medium, said compound of formula I is present in an amount of from 1 wt % to 40 wt %, said compound of formula II is present in an amount of from 1 wt % to 70 wt %, and said compound of formula III is present in an amount of from 10 wt % to 70 wt %.

11. The liquid crystal medium as claimed in claim 10, wherein based on the total weight of said liquid crystal medium, said compound of formula I is present in an amount of from 1 wt % to 25 wt %, said compound of formula II is present in an amount of from 20 wt % to 70 wt %, and said compound of formula III is present in an amount of from 10 wt % to 60 wt %.

12. An active matrix display device, comprising a liquid crystal medium as claimed in claim 4.
